(19) United States
(12) Patent Application Publication
(10) Pub. No.: US 2021/0162434 A1
(43) Pub. Date: Jun. 3, 2021

(54) ELECTROSTATIC ROTARY PROJECTOR FOR COATING PRODUCT AND SPRAYING INSTALLATION COMPRISING SUCH A PROJECTOR

(71) Applicant: EXEL INDUSTRIES, Epernay (FR)

(72) Inventors: Didier Faure, Paris (FR); Olivier Gourbat, Paris (FR); Benoît Vedovati, Paris (FR)

(21) Appl. No.: 17/106,103

(22) Filed: Nov. 28, 2020

(30) Foreign Application Priority Data
Dec. 2, 2019 (FR) 1913624

(51) Int. Cl. B05B 5/04; B05B 5/053; B05B 13/04

(52) U.S. Cl. CPC B05B 5/0407; B05B 13/0431; B05B 5/0533; B05B 5/0415

(57) ABSTRACT

An electrostatic rotary sprayer for a coating product, including a spraying cup, a body, a drive turbine assembled in the body and configured to rotate the spraying cup about an axis of rotation defined by the body. The sprayer also includes electrodes for charging the coating product sprayed by the spraying cup, these electrodes being assembled on a ring attached on the body and each supplied with high voltage through a resistance. Each resistance extends axially outside the ring and is equipped, at its end opposite the electrode that it supplies, with a first electrical connection plug on a second plug of corresponding geometry provided on the body, with a movement parallel to the axis of rotation, and in that the ring is configured to be assembled and connected on the body, or disassembled and disconnected from the body while being equipped with electrodes and resistances.

### CROSS-REFERENCE TO RELATED APPLICATION

This application claims priority of French Patent Application No. 19 13624, filed on Dec. 2, 2019.

### FIELD OF THE INVENTION

The present invention relates to an electrostatic rotary sprayer for a coating product that includes a spraying cup, a body and a turbine assembled in this body configured to rotate the spraying cup about an axis defined by the body.

### BACKGROUND OF THE INVENTION

It is known to charge a coating product leaving the spraying edge of a spraying cup by Corona effect using electrodes positioned on the body of a sprayer and brought to high voltage. The sprayers thus designed are conventionally used to coat easily accessible surfaces, such as the outer surfaces of a body of a motor vehicle.

In this case, as considered in EP-A-2,859,954, the electrodes, a sprayer body and a conformal air discharge skirt can be protected using a cover, so as to prevent them from becoming dirty. The positioning of the electrodes with a configuration diverging toward the front of the sprayer requires the cover to be relatively bulky, which makes the sprayer bulky, to the point that its use must in practice be limited to the outer surfaces of an object, such as a vehicle body.

Furthermore, it is known from US-A-2004/0255849 to assemble electrodes and resistances inside a ring immobilized on the outside of the body of an electrostatic rotary sprayer. This ring equipped with the electrodes tends to become dirty and must therefore be subject to regular disassembly and cleaning operations, which leads to relatively lengthy interruptions in the operation of a spraying installation including such a sprayer. This therefore limits the effective usage duration of such an installation.

These phenomena are even more significant when the sprayers used to coat the inner surfaces of an object, such as the inner surface of a body of a motor vehicle, are highly subject to “overspray”. These sprayers therefore tend to become dirty quickly, in particular at their electrodes.

### SUMMARY OF THE DESCRIPTION

The invention more particularly aims to address these drawbacks by proposing a new electrostatic sprayer for coating product that can be used to coat inner surfaces and that can be cleaned easily and quickly, when necessary.

To this end, the invention relates to an electrostatic rotary sprayer for coating product that includes:
a spraying cup;
a body;
a drive turbine assembled in the body and configured to rotate the spraying cup about an axis of rotation defined by the body; and
electrodes for charging the coating product sprayed by the spraying cup, these electrodes being assembled on a ring attached on the body and each supplied with voltage through a resistance.

According to the invention, each resistance extends axially outside the ring and is equipped, at its end opposite the electrode that it supplies, with a first electrical connection plug for connection on a second plug of corresponding geometry provided on the body of the sprayer, with a movement parallel to the axis of rotation, while the ring is configured to be assembled and connected on the body, or disassembled or disconnected from the body, while being equipped with electrodes and resistances.

Owing to the invention, the ring, equipped with various electrodes and resistances that protrude axially outside the ring, toward the rear of the sprayer, can be disassembled easily from the sprayer when this ring has a level of dirtiness that requires a cleaning operation, which can be done outside the sprayer, in particular during a later coating phase, that is to say during hidden time relative to the usage periods of the sprayer. Since the ring equipped with electrodes and resistances can be assembled/disassembled in a unitary manner, the assembly/disassembly of the ring takes little time, which makes it possible to consider a quick exchange of a ring equipped with dirty electrodes with a ring equipped with clean electrodes, without delaying a production line implementing the sprayer of the invention.

According to advantageous but optional aspects of the invention, such a sprayer may incorporate one or more of the following features, considered in any technically allowable combination:
Each resistance is mounted in a sleeve equipped, at a first end, with an electrode, and at a second end opposite the first end, with the first electrical connection plug.
The sleeve is screwed on the ring.
Part of the electrode is received inside the sleeve and another part of the electrode protrudes outside the sleeve and passes axially through an orifice arranged to that end in the ring.
The body of the sprayer is equipped with sheaths each receiving a sleeve and in that a second plug is aligned, along a direction parallel to the axis of rotation, with each sheath, on the side of this sheath facing toward the rear of the sprayer.
The ring is snapped on the body of the sprayer and/or immobilized on the latter with interposition of a seal.
The body of the sprayer is equipped with a first peripheral snapping relief, while the ring is equipped with a second peripheral snapping relief and, in the assembled configuration of the ring and the electrodes on the body, the first and second snapping relief cooperate in order to immobilize and center, radially to the axis of rotation, the ring on the body of the sprayer.
The first plug or the second plug is of the male plug type with resiliently deformable blades.
All of the resistances and all of the first plugs extend axially on a same side of the ring, facing toward the rear of the sprayer.
The number of electrodes and resistances is inclusively between 13 and 20, preferably between 14 and 18, and preferably equal to 16.
The sprayer also includes a skirt for discharging air around the cup, while an annular slit is defined radially between the ring and the skirt, with its outlet oriented toward the front of the sprayer.
The sprayer also includes a skirt for discharging air around the cup, while the ring equipped with electrodes and resistances is configured to be assembled and connected on the body, or disassembled and disconnected from the body, without disassembly of the cup, and preferably, without disassembly of the skirt.

According to another aspect, the invention relates to an installation for electrostatic spraying of coating product on objects to be coated, which includes at least one sprayer as mentioned above.

Such an installation procures the same advantages as those mentioned above regarding the sprayer.

### BRIEF DESCRIPTION OF THE DRAWINGS

The invention will be better understood, and other advantages thereof will appear more clearly in light of the following description of one embodiment of an installation and a sprayer according to its principle, provided solely as a non-limiting example and done in reference to the appended drawings, in which:

FIG. 1 is a basic perspective illustration of an installation and a sprayer according to the invention;

FIG. 2 is a partially exploded perspective view of the sprayer shown in FIG. 1;

FIG. 3 is a longitudinal sectional view of the sprayer of FIGS. 1 and 2, in plane III of FIG. 1;

FIG. 4 is an enlarged view of detail IV in FIG. 3; and

FIG. 5 is a larger scale view of detail V in FIG. 4.

### DETAILED DESCRIPTION

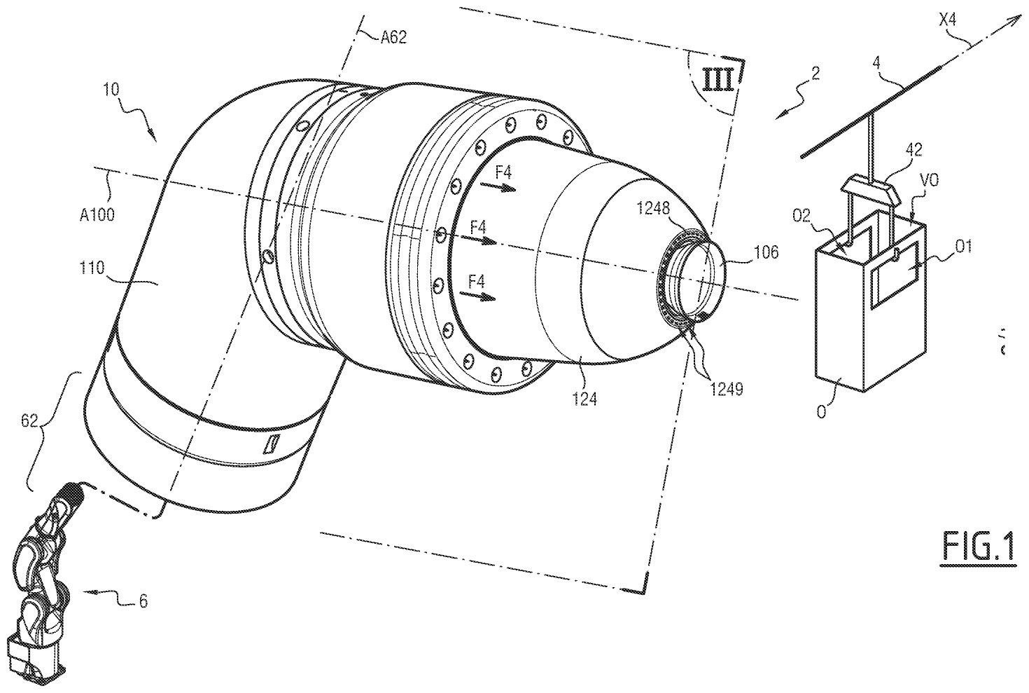

The installation 2 shown very schematically in FIG. 1 is used to coat objects O, which, in the example of the figures, are boxes of electrical cabinets or air-conditioning systems that have openings O1 and O2 and that each define an inner volume VO. These objects O are moved by a conveyor 4, in a conveying direction shown by an axis X4 in FIG. 1. Conveyor 4 includes several cradles 42 that each make it possible to support an object O to be coated and to move it along axis X4.

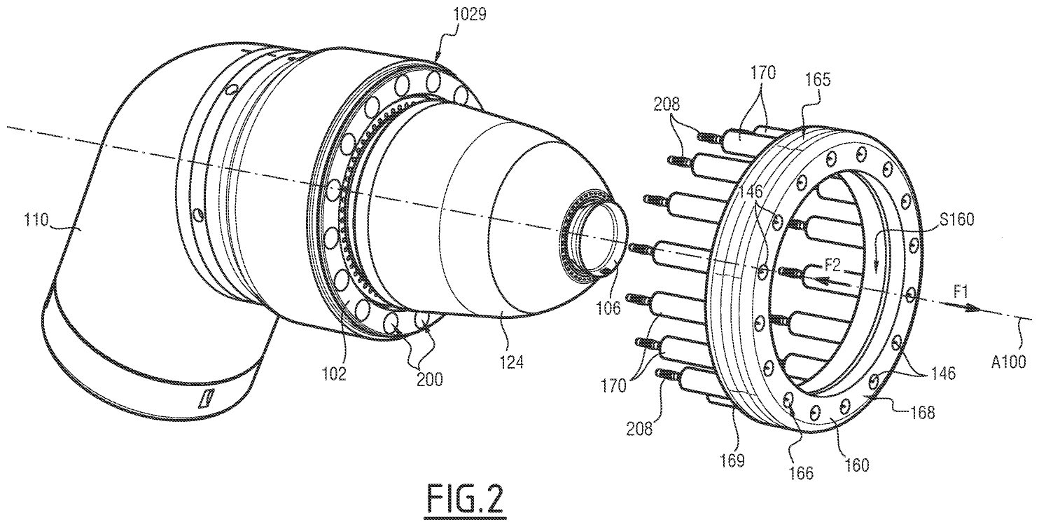

Installation 2 also includes an electrostatic and rotary sprayer 10 that is shown, in FIG. 1, on a larger scale than the other components of installation 2. Sprayer 10 is assembled on a handle 62 of a multiaxial robot 6 that also belongs to installation 2. It is supplied with coating product to be sprayed, high voltage and pressurized air through ducts that are not visible in FIGS. 1 and 2 and that circulate through handle 62.

Sprayer 10 in particular makes it possible to apply a coating product on the inner surfaces of an object O supported by conveyor 4, which delimit its inner volume VO. Sprayer 10 is compact enough to engage in inner volume VO through one of openings O1 or O2.

Sprayer 10 incudes a body 102 on which a turbine 104 is assembled for rotating a cup 106, about an axis of rotation A100 defined by body 102. Cup 106 is secured to the rotor of turbine 104 by any suitable means, in particular by screwing or by magnetic assembly.

Body 102 is assembled on a plate 108 that constitutes the distal face of a bent part 110 of sprayer 10, which makes it possible to off-center axis A100 relative to a central axis A62 of handle 62.

Inside bent part 110, a cable 112 circulates for supplying sprayer 10 with high voltage, for example, a voltage inclusively between −40 and −100 kV, in particular equal to −60 kV. A ground cable 114, a pipe 116 for supplying liquid coating product and a pipe 118 for supplying pressurized air, with an absolute pressure inclusively between 1 and 6 bars, also circulate in bent part 110.

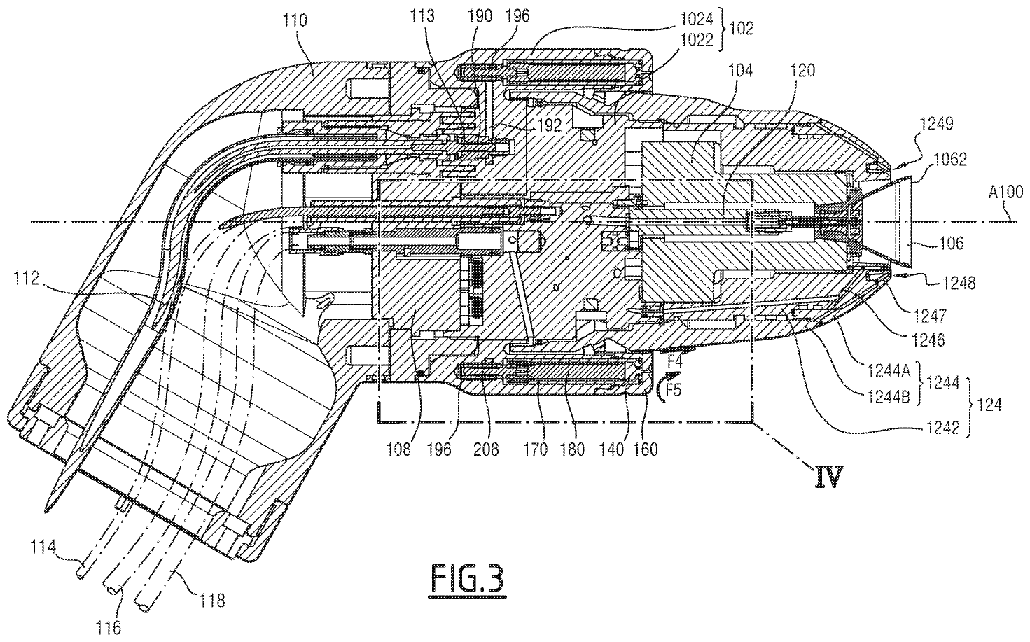

An injector 120 is positioned at the center of turbine 104 and makes it possible to inject liquid coating product into cup 106. The connection between supply pipe 116 and injector 120 is not visible in FIG. 3 because it takes place in a different plane from that of this figure.

As shown in FIGS. 3-5, body 102 is formed by an inner part 1022 and an outer part 1024 that are both assembled on plate 108, in addition to being assembled together.

The front of sprayer 10 is defined as the side of the sprayer facing toward the objects O to be coated when sprayer 10 is operating. Cup 106 is assembled to the front of sprayer 10. The front of sprayer 10 faces toward the right in FIGS. 1-5. The back of sprayer 10 is defined as the side opposite the front, the back of sprayer 10 facing toward the left in FIGS. 1-5, moving away from the objects O relative to cup 106.

Sprayer 10 includes a skirt 124 intended to discharge air around cup 106 when sprayer 10 is operating to coat objects O. Skirt 124 is a sub-assembly of sprayer 10 assembled around body 102 and turbine 104 and which defines air circulation channels up to the vicinity of cup 106. More specifically, body 102 is provided with an outer thread 1021 and skirt 124 is provided with an inner tapping 1241 by which skirt 124 is screwed around body 102.

Skirt 124 includes a monobloc inner part 1242 and an outer part 1244 that has two parts and that includes a front outer part 1244A and a rear outer part 1244B, the front outer part 1244A being located more toward the front of sprayer 10 than the rear outer part 1244B, i.e., closer to cup 106.

Several pressurized air circulation ducts 1246 are arranged in inner part 1242 of skirt 124. Other air circulation ducts 1247 are arranged in outer part 1244. Ducts 1246 and 1247 open onto a front face 1248 of skirt 124, in the form of orifices 1249 distributed around axis A100 and cup 106.

Ducts 1246 and 1247 are supplied with pressurized air from a pipe 118, the connection between these ducts and this pipe taking place in a different plane from that of FIG. 3.

Sixteen electrodes 140 are assembled on an annular ring 160 that is in the form of a closed annulus, with a circular base in the example.

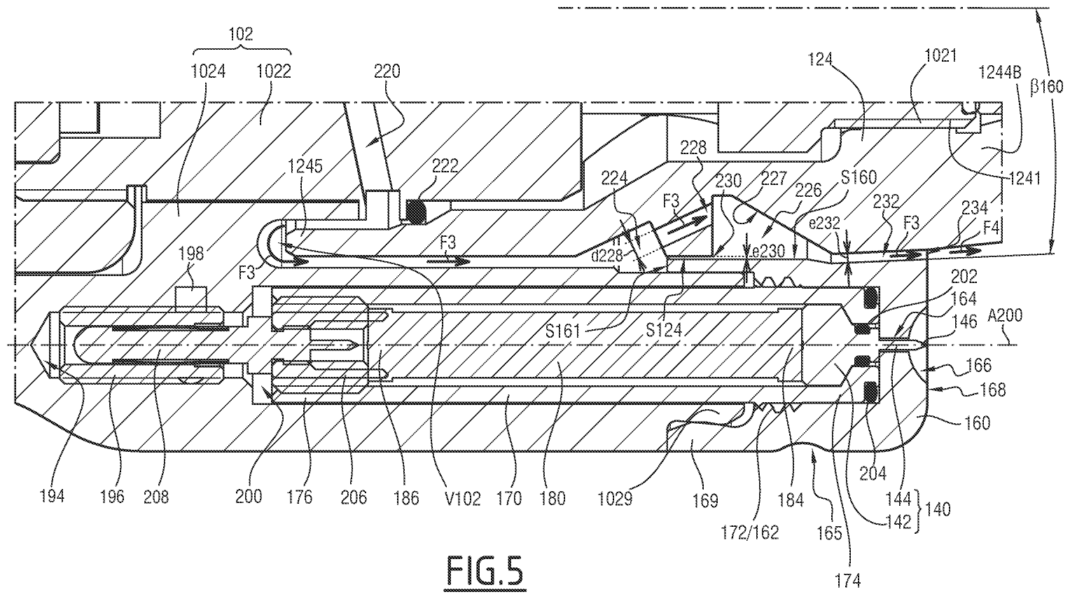

As emerges more particularly from FIG. 5, each electrode 140 incudes a body 142 and a needle 144, the tip of which is denoted 146 and faces toward the front of sprayer 10.

In practice, body 142 of each electrode 140 is housed in a sleeve 170 in which a resistance 180 is also received, through which electrode 140 is supplied with high voltage from cable 112. Reference 184 denotes a first front end of each resistance 180 by which this resistance bears against body 142 of the electrode that it supplies. Reference 186 denotes the second rear end of each resistance that is opposite its first end.

More specifically, a male plug 113 positioned at the end of cable 112 is connected in a female plug 190 of corresponding shape, which is connected, by a conductive bar 192, to one of sixteen blind housings 194 in each of which a female plug 196 is positioned.

Parts 1022 and 1024 of body 102 are made from an electrically insulating material, such as PTFE, and the inner surface of each of blind housings 194 is coated with a conductive powder, for example a carbon-based powder. Furthermore, the conductive layers of blind housings 194 are electrically connected to one another by conductive elements 198 embedded in body 102. Thus, each of female plugs 196 is brought to the high voltage, from high-voltage cable 112.

Body 102 is equipped with sixteen sheaths 200 each aligned with a blind housing 194 along a longitudinal axis A200 that is parallel to axis A100 and radially offset relative thereto. Sheaths 200 are each positioned in front of a blind housing 194. In other words, sheaths 200 are each located in the extension of a blind housing 194, along an axis A200 that is parallel to axis A100, and a female plug 196 is aligned, along an axis A200, with each of sheaths 200, on the back side of this sheath.

Each sleeve 170 is screwed into ring 160 using a thread 172 provided near a first front end 174 of each sleeve. Ring 160 is provided with sixteen tappings 162 allowing screwing of front ends 174 of sleeves 170. Thus, each sleeve 170 is assembled and firmly kept in position on ring 160, all of sleeves 170 and resistances 180 that they contain extending on a same side of ring 160, for the most part outside the latter, toward the back of sprayer 10, toward blind housings 194.

An O-ring 202 is assembled around body 142 of an electrode 140, inside first front end 174 of the corresponding sleeve 170, while another O-ring 204 is assembled between first front end 174 of sleeve 170 and ring 160. O-rings 202 and 204 ensure tightness between the inner volume of a sleeve 170 and the outside.

When a sleeve 170 is screwed and immobilized on ring 160, needle 144 of electrode 140 whose body 142 is contained in this sleeve passes through an orifice 164 arranged in ring 160 and which passes all the way through it, from back to front, such that tip 146 of electrode 140 protrudes in the forward direction. In practice, each tip 146 is positioned in a depression 166 made to that end on front face 168 of ring 160 facing toward the front of sprayer 10. Each tip 146 protrudes from the bottom of a depression 166, toward the front. Advantageously, tips 146 do not protrude toward the front of front face 168, which limits the risks of injury during handling of ring 160, in particular when wiping surface 168.

Ring 160 also includes a snapping member formed by a resiliently deformable tab or strip 169 that extends over the entire periphery of ring 160 and that is provided to cooperate with a complementary snapping relief 1029 provided on the outside of body 102, with a geometry corresponding to that of tab 169. This makes it possible to immobilize ring 160 on body 102 axially and to center it radially to axis A100.

Reference 176 denotes the second rear end of a sleeve 170 opposite its first front end 174.

First front end 184 of each resistance 180 is positioned at first front end 174 of the sleeve that receives it, while second rear end 186 of the resistance is positioned at second rear end 176 of the same sleeve.

An electrical connector 206 is assembled in each sleeve 170, at its rear end 176, and it makes it possible to accommodate a male plug 208 of the “banana plug” type with resiliently deformable outer blades. The second end 186 of each resistance 180 is thus equipped, through a connector 206, with a male plug 208 to which it is connected. All of male plugs 208 extend axially on the same side of ring 140, toward the back of sprayer 10, and parallel to one another.

The geometry of each male plug 208 allows it to cooperate by jamming with a female plug 196 positioned in one of blind housings 194, when sleeve 170 to which it is secured is fully inserted into the corresponding sheath 200, which is aligned with the blind housing 194.

One then reaches the configuration shown in FIGS. 1, 3, 4 and 5, where each of electrodes 140 is supplied with high voltage through a conductive element 198, a female plug 196, a male plug 208, an electrical connector 206 and a resistance 180.

In this configuration, an ion flow can be emitted by each of tips 146 in order to charge the coating product leaving edge 1062 of cup 106, when cup 106 is rotated by turbine 104 and when cup 106 is supplied with coating product through pipe 116. The product leaving cup 106 is thus electrostatically charged by a charge phenomenon called “external” or “Corona”.

If ring 160 tends to become dirty, particularly at depressions 166 or front face 168, it is possible to remove ring 160 by a simple pulling force parallel to axis A100, as shown by arrow F1 in FIG. 2.

Force F1 results in an axial movement of ring 160, the sixteen electrodes 140, the sixteen sleeves 170 and the sixteen male plugs 208 that are secured to ring 160, which results in extracting the first plugs, formed by male plugs 208 and which are movable with ring 160, from the second plugs formed by female plugs 196, which are fixed with body 102.

Movement of first ring 160, electrodes 140, sleeves 170 and resistances 180 takes place without it being necessary to disassemble cup 106 or skirt 124, which remain in place on body 102. Indeed, the inner diameter of ring 160 is strictly greater than the outer diameter of cup 106 and the outer diameter of skirt 124 over its axial length included between cup 106 and ring 160 assembled on body 102.

After the removal of ring 160 and its accessories, it is possible to assemble, in place of elements 140, 160, 170, 180 and 208 previously disassembled, a new sub-assembly including a second ring 160, electrodes 140, resistances 180 and sleeves 170 equipped with male plugs 208 by inserting first male plugs 208 into second female plugs 196, with an axial force, parallel to axis A100, as shown by arrow F2 in FIG. 2.

This placement movement of second ring 160 and the various elements that it supports here again takes place without it being necessary to act on cup 106 or skirt 124, which therefore do not need to be disassembled or reassembled relative to the rest of sprayer 10.

Once second ring 160 and its accessories 140, 170, 180 and 208 are placed, sprayer 10 is once again functional and may be used to coat the objects O, while the first ring, which has been disassembled, may be cleaned during hidden time. The interruption of the operation of installation 2 is therefore limited to the time necessary for disassembly and connection of first ring 160 relative to plugs 196 and assembly of second ring 160 and its connection on plugs 196, these operations taking place by simple axial translation, in the direction of the arrows F1 and F2.

The separating movement of ring 160 and body 102 takes place against the snapping force exerted by elements 169 and 1029. The snapping force may be overcome by an intense enough force F1. In order to facilitate application of this force, ring 160 is provided with a peripheral groove 165 in which the jaws of a tool, not shown, may be engaged, which makes it possible to clamp ring 160 radially, then to exert the pulling force in the direction of arrow F1. Such a tool may, for example, have three jaws, which are distributed radially around axis A100 and which are engaged and clamped in peripheral groove 165 using an annulus that tightens these jaws.

The assembly and connection force of ring 160, in the direction of arrow F2, is a pushing force exerted on front face 168.

During placement of a new ring 160 or replacement of a previously cleaned ring, movement in the direction of arrow F2 continues until snapping members 169 and 1029 engage with one another, which takes place during connection of the first and second plugs 208 and 196.

Cooperation of first and second plugs 208 and 196 makes it possible to center ring 160 and electrodes 140 that it bears relative to body 102, cup 106 and axis A100 due simply to placement of ring 160 around body 102.

Electrodes 140, sleeves 170, plugs 196 and 208, and sheaths 200 are identical. Thus, ring 160 may be assembled on body 102 with any angular orientation around axis A100, with a pitch equal to 360°/16=22.5°.

The assembly and disassembly mode of ring 160 equipped with electrodes 140 and resistances 180 on body 102, which takes place according to two axial translational movements in the direction of arrows F1 and F2, makes it possible to consider an automatic assembly and disassembly of ring 160 on body 102, using a robot. This procures advantages in terms of saved time, repeatability, and reliability of the assembly. This avoids human interventions in a spraying booth, and therefore the associated constraints in terms of equipment, tools and safety conditions to allow access thereto.

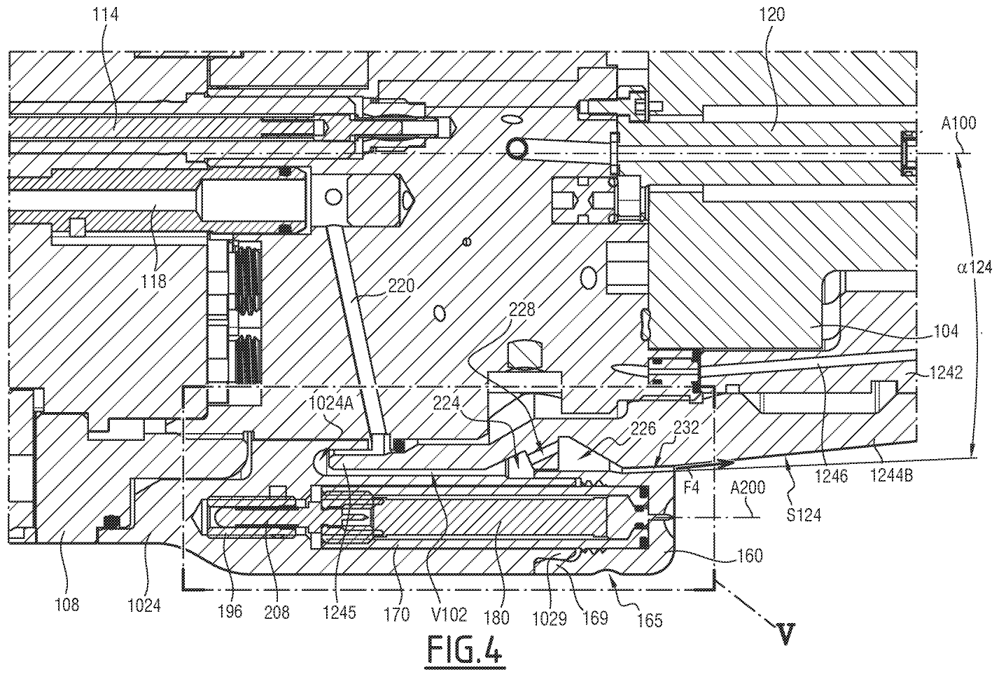

Furthermore, a duct 220 is arranged in inner part 1022 of body 102 and opens out near rear rim 1245 of rear outer part 1244B of skirt 124. More specifically, an annular volume V102 is arranged between parts 1022 and 1024 of body 102 and rear outer part 1244B of skirt 124 extends partially in annular volume V102, with its rear edge 1245 engaged in a peripheral groove 1024A formed by part 1024 of body 102 and which constitutes the rear portion of the annular volume V102. An O-ring 222 delimits annular volume V102 in the forward direction. O-ring 222 is positioned between rear outer part 1244B and inner part 1022 of body 102 and bearing against these parts, which prevents circulation of the air emerging from duct 220 into annular volume V102 toward the front of sprayer 10, between parts 1244B and 1022. Groove 1024A forms a baffle around rear rim 1245 of skirt 124. Air leaving duct 220 must therefore flow into volume V102, in the direction of arrows F3 in FIG. 4, first toward the rear, then toward the front, going around rear rim 1245. Thus, volume V102 constitutes a pressurized air flow chamber, between body 102 and skirt 124, this chamber being delimited in the forward direction by O-ring 222.

In practice, volume V102 is an annular volume, which surrounds certain portions of parts 1022 and 1024 of body 102, and several ducts of the type of duct 220 are provided, which emerge in volume V102 in several locations distributed around inner part 1022 of body 102, which indeed makes it possible to distribute air coming from pipe 118 in volume V102, around axis A100.

Air which flows in the direction of arrows F3 within volume V102, arrives in a first chamber 224 defined between body 102 and skirt 124, which has, in radial section, a globally triangular shape and which is connected to a second chamber 226 by channels 228, the number of which is inclusively between 30 and 90, preferably between 45 and 75, preferably equal to 60. Second chamber 226 is annular and defined between skirt 124 and ring 160. Second chamber 226 is used to distribute air coming from channels 228 radially around axis A100. Channels 228 have an inner diameter d228 inclusively between 1.5 and 2.5 mm, preferably equal to 2 mm. If the channels have a non-circular section, it is the smallest dimension of their cross-section that is inclusively between 1.5 and 2.5 mm, preferably equal to 2 mm. In the case of channels 228 with a circular section, as shown in the figures, their diameter d228 is the smallest dimension of their cross-section.

In a plane radial to axis A100, like the plane of FIGS. 3-5, channels 228 are inclined relative to axis A100, converging forward toward axis A100, which facilitates their production by piercing of rear outer part 1244B of skirt 124, after machining of chambers 224 and 226 in skirt 124. Channels 228 are oriented toward a wall 227 of the annular chamber that is inclined in the forward direction toward ring 160, i.e., divergent in the forward direction relative to axis A100.

The channels are each parallel to a plane radial to axis A100.

In parallel to channels 228, a gap 230 connects chambers 224 and 226. Gap 230 is defined between outer radial surface S124 of skirt 1244 and inner radial surface S160 of ring 160. In other words, between chambers 224 and 226 along axis A100, skirt 124 and ring 160 are not in contact, such that radial gap 230 is formed, with a nonzero radial thickness e230. Radial thickness e230 is smaller than the smallest dimension of a cross-section of a channel 228. In practice, radial thickness e230 of a gap 230 may be chosen between 0.1 and 0.3 mm, preferably equal to 0.2 mm.

Second chamber 226 opens out in the downstream direction, along outer radial surface S124 of skirt 124, by a slit 232 that is annular and the thickness of which is denoted e232, measured radially to axis A100. Radial thickness e232 is chosen between 0.25 and 2 mm, preferably between 0.5 and 1.5 mm, also preferably equal to 1 mm.

At slit 232, outer radial surface S124 is frustoconical and converges toward the front of sprayer 10, toward axis A100. Reference α124 denotes the half-cone angle of surface S124 at slit 232. Still at slit 232, inner radial surface S160 of skirt 160 is also frustoconical and converges toward the front toward axis A100. Reference β160 denotes the half-cone angle of surface S160 at slit 232. Angles α124 and β160 have the same value. In other words, inner radial surface S160 of ring 160 locally marries the outer shape of skirt 124. Thickness e232 is thus constant over the length of slit 232.

In practice, radial thickness e232 is chosen to be strictly less than the smallest dimension of a cross-section of a duct 228, therefore than its diameter d228 in the case of a duct 228 with a circular section. Thus, flow of air in second chamber 226 accelerates in passing through ducts 228 to slit 232.

Furthermore, since the channels are oriented toward surface 227, air is distributed effectively around axis A100, in circulating along this surface, before reaching slit 232.

Air opens out from slit 232 by an outlet 234 oriented toward the front of the sprayer, which sends air along the outer surface S124 of skirt 124, as shown by arrow F4 in FIGS. 3-5, with a sufficient speed to travel along surface S124, into the vicinity of front face 128 of skirt 124. Preferably, the geometry of surface S124 and that of inner radial surface S160 of ring 160 are chosen such that thickness e232 is constant along slit 232. Outlet 234 of slit 232 then also has radial thickness e232.

This tends to facilitate the fact that air flow leaving slit 232 follows surface S124 by Coanda effect. Preferably, in order to facilitate this Coanda effect, the convergence angle toward the front of surface S124 toward axis A100 is chosen to be less than or equal to 7°.

Thus, slit 232 makes it possible to orient, through its outlet 234, an air flow shown by arrow F4 toward the part of the sprayer located in front of ring 160 and electrodes 140. Air flow F4, which can be described as an air knife, preferably flows continuously when the sprayer is operating and it sweeps over the outer surface of sprayer 10, in particular outer surface S124 of skirt 124, which prevents or greatly limits the deposits of coating product on this surface. Sprayer 10 is less inclined to become dirty and the cleaning operations may be more spread out over time than with known sprayers.

The air flow rate exiting through slit 232, in the direction of arrow F4, is preferably less than the total skirt air flow rate discharged through orifices 1249. As an example, for a skirt air flow rate inclusively between 300 and 800 liters per minute (l/mn), the air flow rate discharged by slit 232 may be on the order of 300 l/mn. In practice, in this case, the air flow rate discharged by slit 232 may be chosen to be between 100 and 500 l/mn, preferably between 200 and 400 l/mn, the value of 300 l/mn having proven to be particularly effective.

Air exiting from slit 232 in the direction of arrow F4 has a driving effect by suction on the adjacent air, in particular on the air located in front of front face 168 of ring 160. This driving effect creates an air current shown by arrow F5 in FIG. 3, which facilitates cleaning of front face 168 and of the depressions 166 in the process of spraying or prevents overspray deposits, in the case where coating product residues tend to become deposited.

During operation, it is possible to monitor the high voltage applied to electrodes 140, which makes it possible to detect any runaway of the electrostatic charge phenomenon or, on the contrary, a rapid decrease in this phenomenon, which could come from dirtying of electrodes 140 or of the adjacent parts of the sprayer, in particular skirt 124. In case of drift of the voltage relative to a nominal value, for example −60 kV, the supply rate of pressurized air to volume V102 and slit 232 may be temporarily increased, so as to quickly clean any deposit of coating product or moisture from surface S124. In particular, the supply rate of pressurized air to volume V102 and slit 232 may be doubled in this case.

In this respect, in case of moisture risk, it is possible to consider that air conveyed to volume V102, therefore air discharged by slit 232, may be hotter than the ambient air. In other words, air supplying the slit 232 may be heated relative to the ambient air around the sprayer, which improves the drying effect of surface S124 owing to air flow leaving slit 232 through its outlet 234.

According to another aspect of the invention, which can be applied in conjunction with or in place of those mentioned above, air supplying annular slit 232 may be electrically polarized. For example, electrodes, not shown, may be positioned in duct 118 or ducts 220 and in the parallel ducts in order to charge air with a polarity opposite that of the voltage applied on electrodes 140. Under these conditions, air leaving slit 232 has the same polarity as the particles of coating product ejected by edge 1062 of cup 106, which results in pushing these particles back toward the front of the sprayer, while limiting dirtying of surface S124 and of ring 160, in particular of its front face 168. Such polarization of air discharged through slit 232 may be considered continuously or only in case of drift of the high voltage value delivered at electrodes 140.

Annular slit 232 and air leaving it when the sprayer is operating facilitate cleaning of sprayer 10 within a rinsing box. In this type of equipment, it is typical to bring part of a sprayer into contact with one rim of the rinsing box, with an interposed seal. It is also typical to provide, in the rinsing box, an inner air jet and/or a device for scraping the outer surface of the sprayer. The air flow shown by arrow F4 makes it possible to do away with this seal, inner air jet and/or scraping device because it continuously cleans the front part of the sprayer, including when the latter is engaged in the rinsing box. This provides greater freedom in the design of the outer shape of body 102 and skirt 124. Furthermore, the air knife, which leaves slit 232 by its outlet 234, as shown by arrows F4, makes it possible to confine any splashes of cleaning product and coating product to the inside of the rinsing box. In terms of the method, it is possible to provide that the chamber formed by volume V102 is supplied with a maximum air flow rate when the sprayer is engaged in the rinsing box, which procures a maximum cleaning/drying effect during this phase of a spraying method implementing sprayer 10. Owing to the air knife formed by the air flow leaving slit 232 through its outlet 234, the drying time of the sprayer is decreased, which decreases the immobilization time of the sprayer in the rinsing box. Passage of the sprayer in the rinsing box makes it possible to space out the disassemblies/reassemblies of electrode 160 relative to body 102.

When the sprayer is assembled, as shown in FIGS. 1 and 3-5, ring 160, and in particular electrodes 140 and slit 232 are offset, along axis A100, toward the rear, relative to edge 1062 of the cup and relative to outlet orifices 1249 of skirt 124. More specifically, tips 146 of electrodes 140 and outlet of slit 232 toward the outside are further from edge 1062 and orifices 1249 than skirt 124 front outer part 1244A. Furthermore, along axis A100, annular slit 232 is positioned in the vicinity of tips 146, which are also offset toward the rear relative to orifices 1249. “In the vicinity of” means that, along axis A100, tips 146 of electrodes 140 are located less than 5 mm from slit 232.

The invention is applicable with a liquid coating product, as mentioned above, or in a variant, with a powdered coating product.

According to one embodiment of the invention that is not shown, disassembly of ring 160 may take place owing to a tool that exerts a pulling force not on the outside of the ring, at peripheral groove 165, but by the inside of ring 160. In this case, when ring 160 must be removed, skirt 124 is disassembled, while keeping cup 106 in place on turbine 104 if the diameter of the cup is smaller than the inner diameter of skirt 124. If the diameter of cup 106 is greater than or equal to the inner diameter of skirt 124, like in the example of the figures, cup 106 is disassembled from the turbine prior to disassembly of skirt 124 relative to body 102. In all cases, disassembly of skirt 124 occurs by unscrewing ring 160 relative to body 102, by disengaging tapping 1241 from thread 1021. It is then possible to screw, on thread 1021, the body of a tool, not shown, that is provided with resilient tabs that extend toward the rear of sprayer 10, past a surface S161 of the ring that is radial to axis A100 and facing toward the rear of the sprayer. These tabs deform resiliently in order to pass radially to the center of ring 160, between ring 160 and body 102, to the inside of volume V102, during assembly of the tool on body 102. Free ends of the resilient tabs have harpoon-shaped tips, which, when the tabs regain their non-stressed configuration, engage behind surface S161. The harpoon-shaped tips are distributed around body 102, therefore able to exert an axial force on surface S161 in the direction of arrow F1, this force being distributed around axis A100 due to the multiplicity of the tabs in question. This force is exerted when, after having engaged the harpoon-shaped tips of the tabs of the tool behind surface S161, the tool is unscrewed relative to body 102. This force makes it possible to disassemble ring 160 relative to body 102, subject to the removal of skirt 124, and optionally of cup 106. This allows for easy disassembly of ring 160 owing to the guiding of the tool on the thread, which guarantees a pulling force, shown by arrow F1, which is along axis A100. Additionally, the force is increased by the screw pitch.

In a variant, the number of electrodes 140 is different from sixteen. Preferably, this number is chosen between 13 and 20, in particular between 14 and 18. The fact that the number of electrodes is strictly greater than 12 means that the angular gap around axis A100 between two adjacent electrodes is strictly less than 30°. Thus, the portion of front face 168 of ring 160 that is exposed to overspray between two tips 146 is relatively small, which limits the area of the surfaces of ring 160 to be cleaned. In all cases, the number of sleeves 170, resistances 180 and first plugs 208 is equal to the number of electrodes 140.

According to a variant of the invention that is not shown, first plugs 208 secured to ring 160 are female plugs, while second plugs 196 secured to body 102 are male plugs.

According to another variant, the structure and the geometry of skirt 124 may be different from that shown in the figures. In particular, the number of component parts of skirt 124 may be different than three.

According to still another variant, channels 228 may have an orthoradial component, to the point that air leaving from these channels has an orthoradial component resulting in a vortex component of air leaving from slit 232.

The section of channels 228 may be different than circular.

Furthermore, the channels may be made, in whole or in part, in body 102, instead of in skirt 124.

According to still another variant, snapping members 169 and 1029 may be replaced by a seal positioned between body 102 and ring 160, this seal making it possible to center and jam the ring on the body. This seal is advantageously an O-ring.

In the example, the supply circuit supplying slit 232 with pressurized air extends at once in body 102, in the form of ducts 220, in skirt 124, in the form of ducts 228, between body 102 and skirt 124, in the form of volume V102, and between skirt 124 and ring 160, in the form of gap 230. In a variant, this circuit extends only in one or another of these parts or only between two of them.

The objects O on which the coating product is applied in the installation of the invention may be objects other than boxes, in particular motor vehicle bodies. Sprayer 10 is particularly suited to application of coating product to the inside of such bodies.

In a variant, multiaxial robot 6 may be replaced by another type of robot, in particular a reciprocator.

The invention makes it possible to consider, with time, dropping the entire outer casing of the sprayer and picking up a clean casing without stopping production, at a frequency depending on the application conditions and types. According to such an approach, the cup, skirt and electrode are dropped when they are dirty. A whole clean set is taken up and cleaning of the first casing is done during hidden time. It is even possible to consider moving toward dropping/taking up all of the parts in contact with the paint cloud or with the overspray, which would be difficult, if not impossible, with the external charge electrodes of the prior art.

The embodiments and variants considered above may be combined with one another to generate other embodiments of the invention.

1. An electrostatic rotary sprayer for coating product, comprising:
a spraying cup;
a body;
a ring attached to said body;
a drive turbine assembled in said body and configured to rotate said spraying cup about an axis of rotation defined by said body; and
electrodes for charging the coating product sprayed by said spraying cup, the electrodes being assembled on said ring and each electrode supplied with high voltage through a resistance, wherein each resistance extends axially outside said ring and is equipped, at its end opposite the electrode that it supplies, with a first electrical connection plug for connection on a second plug of corresponding geometry provided on said body, with a movement parallel to the axis of rotation, and wherein said ring is configured to be assembled and connected on said body, or disassembled and disconnected from said body while being equipped with said electrodes and resistances.

2. The sprayer according to claim 1, wherein each resistance is mounted in a sleeve equipped, at a first end, with one of said electrodes, and at a second end opposite the first end, with the first electrical connection plug.

3. The sprayer according to claim 2, wherein the sleeve is screwed on said ring.

4. The sprayer according to claim 2, wherein part of the one of said electrodes is received inside the sleeve and another part of the one of said electrodes protrudes outside the sleeve and passes axially through an orifice arranged to that end in said ring.

5. The sprayer according to claim 2, wherein the body of the sprayer is equipped with sheaths each receiving a sleeve, and wherein the second plug is aligned, along a direction parallel to the axis of rotation, with each sheath, on the side of the sheath facing toward the rear of the sprayer.

6. The sprayer according to claim 1, wherein said ring is snapped on said body and/or immobilized on said body with interposition of a seal.

7. The sprayer according to claim 1, wherein said body is equipped with a first peripheral snapping relief, wherein said ring is equipped with a second peripheral snapping relief and wherein, in the assembled configuration of said ring and said electrodes on said body, the first and second snapping relief cooperate in order to immobilize and center, radially to the axis of rotation, said ring on said body.

8. The sprayer according to claim 1, wherein the first plug or the second plug is of the male plug type with resiliently deformable blades.

9. The sprayer according to claim 1, wherein all of the resistances and all of the first plugs extend axially on a same side of said ring, facing toward the rear of the sprayer.

10. The sprayer according to claim 1, wherein the number of said electrodes and resistances is inclusively between 13 and 20.

11. The sprayer according to claim 1, wherein the number of said electrodes and resistances is inclusively between 14 and 18.

12. The sprayer according to claim 1, wherein the number of said electrodes and resistances is inclusively between 16 and 18.

13. The sprayer according to claim 1, wherein the number of said electrodes and resistances is equal to 16.

14. The sprayer according to claim 1, further comprising a skirt for discharging air around said spraying cup and wherein an annular slit is defined radially between said ring and said skirt, with its outlet oriented toward the front of the sprayer.

15. The sprayer according to claim 1, further comprising a skirt for discharging air around said spraying cup, and wherein said ring is configured to be assembled and connected on said body, or disassembled and disconnected from said body, without disassembly of said spraying cup.

16. The sprayer according to claim 15, wherein said ring is configured to be assembled and connected on said body, or disassembled and disconnected from said body, without disassembly of said skirt.

17. An electrostatic spraying installation for spraying coating product on objects to be coated, comprising at least one sprayer according to claim 1.
